(19) United States
(12) Patent Application Publication
(10) Pub. No.: US 2004/0093391 A1
(43) Pub. Date: May 13, 2004

(54) Computer console for wirelessly controlling remote computers

(76) Inventor: Heng-Chien Chen, Taipei-City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,657

(22) Filed: Nov. 7, 2002

(51) Int. Cl. G06F 15/16

(52) U.S. Cl. 709/217

(57) ABSTRACT

A control system uses a console to control a plurality of computer systems. Each computer system includes an adapter electrically connected to a computer for sending signals to and receiving signals from the computer, the adapter including a first transceiver for wirelessly sending status signals and for wirelessly receiving control signals. The control system also includes the console, including a controller for controlling communications between the console and the computer system. The controller contains a second transceiver for wirelessly sending the control signals to the first transceiver of the adapter and for wirelessly receiving the status signals sent from the first transceiver of the adapter. The console also contains input devices connected to the controller for inputting the control signals to the controller, and at least one output device connected to the controller for outputting the status signals received by the second transceiver of the controller.

### BACKGROUND OF INVENTION

1. Field of the Invention

The present invention relates to a computer console for controlling a plurality of computers, and more specifically, to a computer console with a transceiver for wirelessly controlling a plurality of remote computers.

2. Description of the Prior Art

Computer consoles are commonly used in order to control a plurality of computers through a single computer console. In this arrangement, each of the computers being controlled is connected to a controller on the console, and each of the computers can be controlled through the console. Because the console is used as a primary interface for users, each computer being controlled by the console does not require traditional input and output devices, such as a mouse, keyboard, or monitor, directly connected to the computer. The use of a console to control other computers is well known in the art, and a brief description will be given in order to better illustrate the present invention.

Please refer to FIG. 1. FIG. 1 is a block diagram of a console 10 used to control a plurality of computers 22 according to the prior art. The console 10 contains a controller 12, a monitor 14, a keyboard 16, and a mouse 18. The monitor 14 is used to provide a user with video output from the controller 12. The keyboard 16 and the mouse 18 are used to allow the user to input commands to the controller 12. Each of the plurality of computers 22 is connected to an adapter 20. The adapter 20 is what allows the computer 22 to communicate with the controller 12 of the console 10, and the controller 12 can be switched to connect with at least one computer 22 at a time through the use of the corresponding adapter 20.

As shown in FIG. 1, the computer 22 sends video output signals to the adapter 20, the adapter 20 then sends these video signals to the controller 12, and finally the controller 12 provides the video output to the monitor 14. On the other hand, input control signals from the keyboard 16 and the mouse 18 are sent to the controller 12, the controller 12 then sends these input signals to the adapter 20, and finally the adapter 20 provides the input signals to the computer 22. In this way, the user of the console 10 can use the keyboard 16 and the mouse 18 to control the computer 22, and the user can also receive video output from the computer 22 on the monitor 14 of the console 10.

Unfortunately, the prior art console 10 and adapters 20 are connected together with wired connections. Thus, expensive cable must be run between each adapter 20 and the console 10. If one of the computers 22 is to be moved, care must be taken to ensure that the cable connecting the corresponding adapter 20 to the console 10 is long enough to reach the new location of the computer 22. In addition, if computers 22 are located in a different room from the console 10, it is troublesome to run wires to connect the console 10 to the corresponding adapters 20 of the computers 22.

### SUMMARY OF INVENTION

It is therefore a primary objective of the claimed invention to provide a control system for using a computer console with a transceiver to wirelessly control a plurality of computer systems in order to solve the above-mentioned problems.

According to the claimed invention, a control system includes a plurality of computer systems each comprising an adapter electrically connected to a computer for sending signals to and receiving signals from the computer, the adapter comprising a first transceiver for wirelessly sending status signals and for wirelessly receiving control signals. The control system also includes a console, including a controller for controlling communications between the console and the computer system, the controller comprising a second transceiver for wirelessly sending the control signals to the first transceiver of the adapter and for wirelessly receiving the status signals sent from the first transceiver of the adapter. The console also contains at least one input device connected to the controller for inputting the control signals to the controller, and at least one output device connected to the controller for outputting the status signals received by the second transceiver of the controller.

It is an advantage of the claimed invention that the control system allows the console to wirelessly communicate with the computer systems, eliminating the need for expensive cables used to connect the console to the computer systems. In addition, computers can easily be moved, or positioned in a different room from the console without concern for the length of the wires.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a console used to control a plurality of computers according to the prior art.

FIG. 2 is a block diagram of a console used to control a plurality of computers according to the present invention.

FIG. 3 is a block diagram of the console according to the present invention.

FIG. 4 is a block diagram of an adapter connected to a corresponding computer according to the present invention.

### DETAILED DESCRIPTION

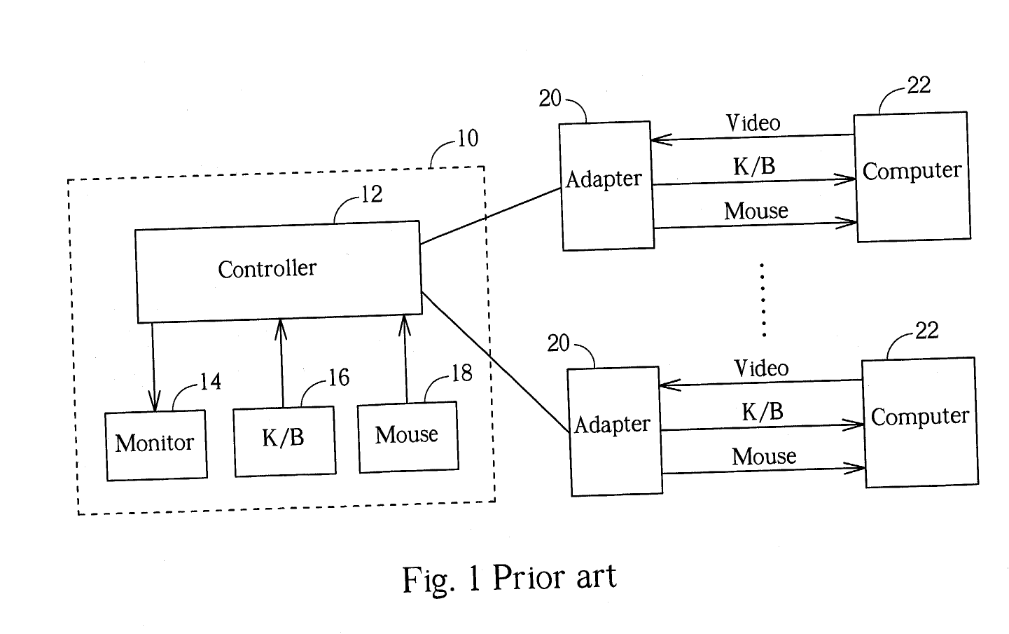

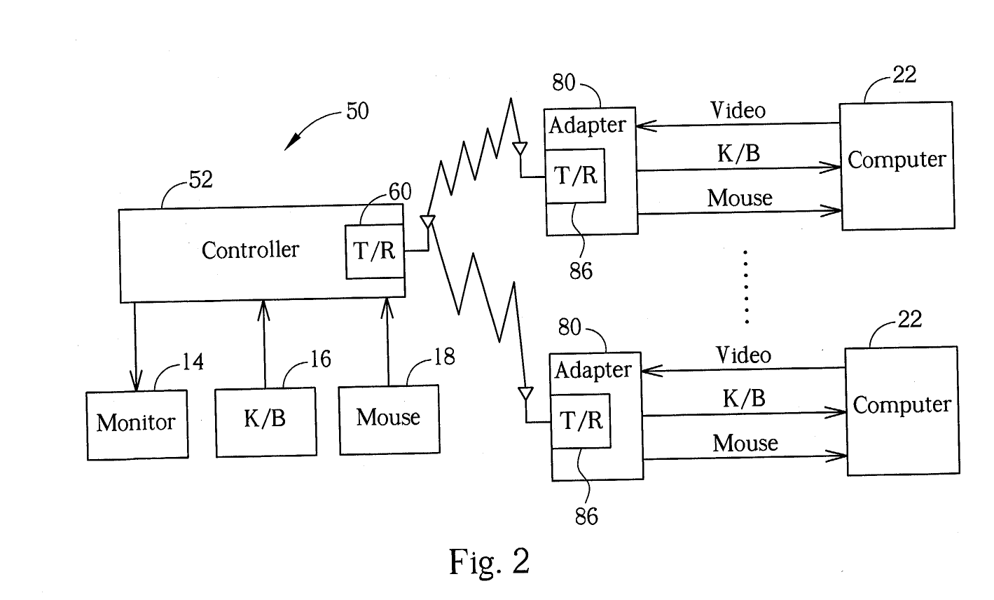

Please refer to FIG. 2. FIG. 2 is a block diagram of a console 50 used to control a plurality of computers 22 according to the present invention. Since the present invention is designed to work with a conventional computer 22, monitor 14, keyboard 16, and mouse 18, each of these devices is provided with the same reference numerals used in the description of the prior art in FIG. 1. The difference between the prior art and the present invention lies in the interaction between a controller 52 of the console 50 and an adapter 80 connected to the computer 22. Specifically, the controller 52 contains a transceiver 60 for wirelessly communicating with a transceiver 86 of the adapter 80.

Other then the wireless communication between the controller 52 and the adapter 80, the basic operation of the console 50 is the same as with the prior art. That is, the computer 22 sends video output signals to the adapter 80, the adapter 80 then sends these video signals to the controller 52, and finally the controller 52 provides the video output to the monitor 14. On the other hand, input control signals from the keyboard 16 and the mouse 18 are sent to the controller 52, the controller 52 then sends these input signals to the adapter 80, and finally the adapter 80 provides the input signals to the computer 22. In this way, the user of the console 50 can use the keyboard 16 and the mouse 18 to control the computer 22, and the user can also receive video output from the computer 22 on the monitor 14 of the console 50. As explained above, the transceiver 60 of the controller 52 is used to wirelessly communicate with the transceiver 86 of the adapter 80. This wireless communication eliminates the need for wires connecting the controller 52 and the adapter 80.

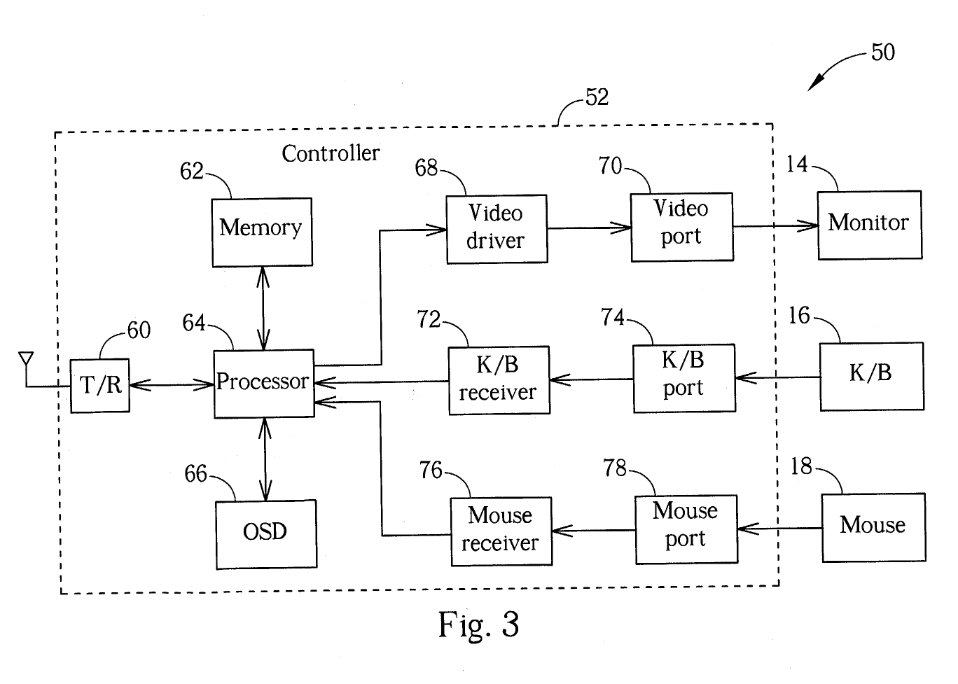

Please refer to FIG. 3. FIG. 3 is a block diagram of the console 50 according to the present invention. The controller 52 is shown connected to the monitor 14, keyboard 16, and mouse 18. The keyboard 16 and the mouse 18 are connected to a keyboard port 74 and a mouse port 78, respectively, for inputting control signals to the controller 52. The keyboard port 74 and the mouse port 78 may use any type of connector, such as PS/2 or RS-232 connectors. Inputted control signals from the keyboard port 74 and the mouse port 78 are respectively sent to a keyboard receiver circuit 72 and a mouse receiver circuit 76 for receiving these inputted control signals. The keyboard receiver circuit 72 and the mouse receiver circuit 76 then each send received control signals to a processor 64 so that the signals can be appropriately packaged and compressed for wireless transmission. Finally, the processor 64 sends the packaged control signals to the transceiver 60 for transmission to the adapter 80. In this way, control signals from the keyboard 16 and mouse 18 are sent to the adapter 80 for controlling the computer 22. The processor 64 is also connected to a memory 62 and an on screen display (OSD) circuit 66. The memory 62 stores an operating system used to run the controller 52. The OSD circuit 66 is used to aid a user in configuring the controller 52 by providing on screen menus for the user to select from.

In addition to sending wireless signals to the adapter 80, the transceiver 60 is also used to receive video output signals from the computer 22 via the transceiver 86 of the adapter 80. These video output signals are sent from the transceiver 60 to the processor 64 for unpacking and decompression. The video signals are then sent to a video driver circuit 68 for providing the video signals to a video port 70. Again, the video port can use any kind of video connector for use with a monitor, such as a DB15 or HD15 connector. Finally, the video output signals are sent through the video port 70 to the monitor 14 for output display.

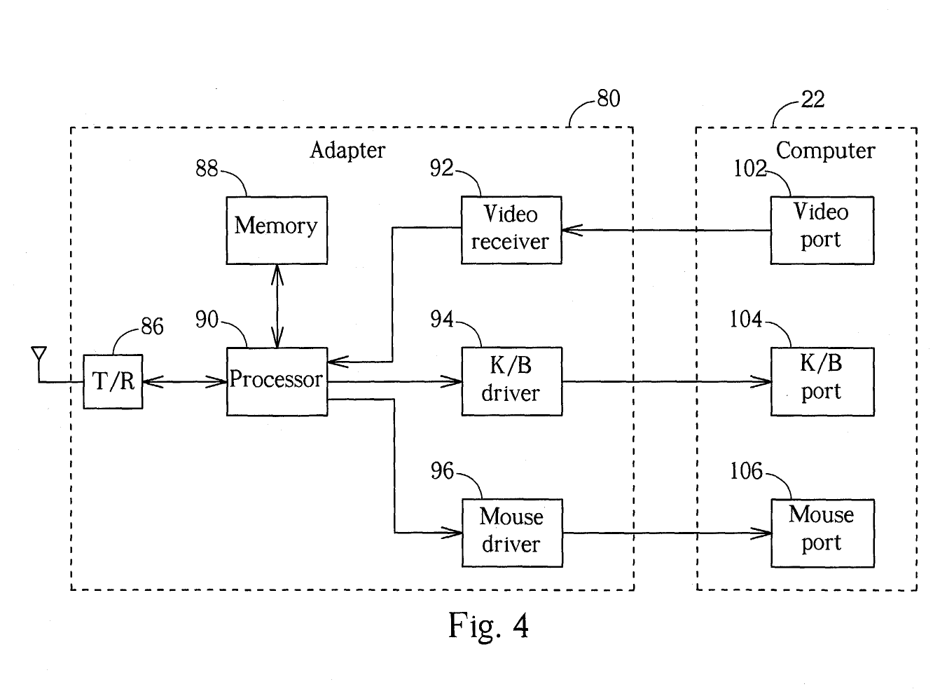

Please refer to FIG. 4. FIG. 4 is a block diagram of the adapter 80 connected to a corresponding computer 22 according to the present invention. Input control signals sent from the keyboard 16 and mouse 18 via the transceiver 60 of the controller 52 are received by the transceiver 86 of the adapter 80. The transceiver 86 then sends the signals to a processor 90 for unpacking and decompression. The processor 90 then respectively sends control signals from the keyboard 16 and mouse 18 to a keyboard driver circuit 94 and a mouse driver circuit 96. The keyboard driver circuit 94 and the mouse driver circuit 96 then respectively provide the control signals to a keyboard port 104 and a mouse port 106 of the computer 22. Thus, input commands from the keyboard 16 and mouse 18 of the console 50 are able to control the computer 22 via the adapter 80. The processor 90 is also connected to a memory 88, which stores an operating system used to run the controller 80.

In addition to receiving wireless signals from the controller 52, the transceiver 86 is also used to transmit video output signals from the computer 22 to the controller 52. Video output signals are sent from a video port 102 of the computer 22 to a video receiver circuit 92 of the adapter 80. The video receiver circuit 92 then sends the video output signals to the processor 90 for packaging and compression. Finally, the processor 90 sends the video output signals to the transceiver 86 for transmission to the controller 52. Thus, a user of the console 50 is able to receive feedback in the form of video output from the computer 22 while controlling the computer 22 with the keyboard 16 and the mouse 18.

In a preferred embodiment of the present invention, all wireless signals used in communication between the transceiver 60 of the controller 52 and the transceiver 86 of the adapter 80 are direct sequence spread spectrum (DSSS) signals that conform to the IEEE 802.11b networking standard.

Compared to the prior art, the present invention console is able to wirelessly communicate with the adapter of a corresponding computer. Thus, whenever an additional computer is to be controlled by the console, no new wires need to be used to connect the computer to the console. The present invention control system eliminates the need for expensive cables used to connect the console to the computer systems. In addition, computers can easily be moved, or positioned in a different room from the console without concern for the length of the wires.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A control system comprising:
a plurality of computer systems each comprising an adapter electrically connected to a computer for sending signals to and receiving signals from the computer, the adapter comprising a first transceiver for wirelessly sending status signals and for wirelessly receiving control signals; and
a console comprising:
a controller for controlling communications between the console and the computer system, the controller comprising a second transceiver for wirelessly sending the control signals to the first transceiver of the adapter and for wirelessly receiving the status signals sent from the first transceiver of the adapter;
at least one input device connected to the controller for inputting the control signals to the controller; and
at least one output device connected to the controller for outputting the status signals received by the second transceiver of the controller.

2. The control system of claim 1 wherein the adapter of the computer system further comprises a first processor electrically connected to the first transceiver for controlling operation of the adapter.

3. The control system of claim 2 wherein the controller of the console further comprises a second processor electrically connected to the second transceiver for controlling operation of the controller.

4. The control system of claim 3 wherein the input device is a mouse connected to the controller of the console, and the control signals inputted from the mouse to the controller are wirelessly transmitted from the second transceiver to the first transceiver of the adapter such that the mouse connected to the console is capable of controlling the computer connected to the adapter.

5. The control system of claim 4 wherein the controller of the console further comprises a mouse receiver circuit electrically connected between the second processor and the mouse for sending the control signals received from the mouse to the second processor.

6. The control system of claim 4 wherein the adapter of the computer system further comprises a mouse driver circuit electrically connected between the first processor and the computer for sending control signals from the adapter to the computer.

7. The control system of claim 3 wherein the input device is a keyboard connected to the controller of the console, and the control signals inputted the keyboard to the controller are wirelessly transmitted from the second transceiver to the first transceiver of the adapter such that the keyboard connected to the console is capable of controlling the computer connected to the adapter.

8. The control system of claim 7 wherein the controller of the console further comprises a keyboard receiver circuit electrically connected between the second processor and the keyboard for sending the control signals received from the keyboard to the second processor.

9. The control system of claim 7 wherein the adapter of the computer system further comprises a keyboard driver circuit electrically connected between the first processor and the computer for sending control signals from the adapter to the computer.

10. The control system of claim 3 wherein the output device is a video monitor connected to the controller of the console, and the status signals of the computer that are wirelessly transmitted by the first transceiver to the second transceiver are video signals that are displayed on the monitor for providing a video status of the computer to the console.

11. The control system of claim 10 wherein the controller of the console further comprises a video driver circuit electrically connected between the second processor and the monitor for sending the video signals received by the second processor to the monitor.

12. The control system of claim 10 wherein the adapter of the computer system further comprises a video receiver circuit electrically connected between the first processor and the computer for sending video signals received from the computer to the first processor.

13. The control system of claim 1 wherein the wireless signals transmitted between the first transceiver to the second transceiver are direct sequence spread spectrum signals.

14. The control system of claim 1 wherein the wireless signals transmitted between the first transceiver to the second transceiver conform to the IEEE 802.11b networking standard.
